(19) United States
(12) Patent Application Publication
(10) Pub. No.: US 2004/0239717 A1
(43) Pub. Date: Dec. 2, 2004

(54) Alumina sintered body and ink-jet recording head structure

(75) Inventors: Takehisa Higa, Gamo-gun (JP); Takashi Kono, Gamo-gun (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 10/788,013

(22) Filed: Feb. 26, 2004

(30) Foreign Application Priority Data
Feb. 26, 2003 (JP) 2003-49439

(51) Int. Cl. B41J 2/015

(52) U.S. Cl. 347/20

(57) ABSTRACT

Provided is an alumina sintered body including not less than 99.3% by weight of Al₂O₃, not more than 0.25% by weight of SiO₂, not more than 0.3% by weight of MgO, and not more than 0.3% by weight of CaO, and having a surface open porosity of less than 5%, and an average open pore diameter of not more than 5 μm. This alumina sintered body is applied to at least a surface exposed to ink in an ink jet recording head structure. This suppresses the elution of glass component of the alumina sintered body into ink, thereby stabilizing ink viscosity. This also suppresses falling of grains that causes clogging of ink discharge holes.

Priority is claimed to Japanese Patent Application No. 2003-49439 filed on Feb. 26, 2003, the disclosure of which is incorporated by reference in its entirety.

### BACKGROUND OF THE INVENTION

1. Field of the Invention

The present invention relates to an alumina sintered body, an ink jet recording head structure to be mounted on a recording apparatus of ink jet printing system, as well as an ink jet printer.

2. Description of Related Art

Recording apparatuses of ink jet printing system have been used as means for printing characters and images in colors on paper. Recently, there have been demands for higher density of printing along with high precision of image output.

Examples of ink jet recording head structures to be mounted on a recording apparatus of ink jet printing system are those which may utilize thermal energy developed by a heat generating resistor or deformation of a piezoelectric element or heat developed by irradiation of electromagnetic wave, as mechanism for discharging and ejecting ink droplets to recording paper.

As shown in a sectional view of FIG. 7, for example, an ink jet recording head structure 31 that employs the thermal energy of a heat generating resistor as a pressurizing mechanism comprises an ink jet recording head 32 consisting of a flow passage member 33 having a plurality of ink chambers 34 and heat generating resistors 35 for pressurizing ink disposed in the respective ink chambers 34, and a nozzle plate 39 having ink discharge holes 38 in communication with the respective ink chambers 34; and a support member 40 that supports the ink jet recording head 32 and has ink delivery hole 41 in communication with the ink chambers 34 of the flow passage member 33. The ink delivery hole 41 consists of an elongated hole 42 having an inclined bottom surface 43 that is opened to the ink jet recording head 32 and further deepened toward the center, and a small-diameter hole 44 in communication with the elongated hole 42.

Printing on a recording paper with use of the ink jet recording head structure 31 is performed as follows. In a state in which ink is supplied from the ink delivery hole 41 to the ink chambers 34, the heat generating resistor 35 is caused to develop heat so as to generate bubbles A in the ink chambers 34 thereby to pressurize the ink in the ink chambers 34, so that ink droplets B are discharged through the ink discharge holes 38 (see Japanese Patent Application Laid-Open No. 2001-130004).

Meanwhile, as a material of the support member 40 as shown in FIG. 7, an alumina sintered body has heretofore been used taking the cost into consideration. The support member 40, which has the elongated hole 42 with the inclined bottom surface 43 further deepened toward the center, and the small-diameter hole 44 in communication with the elongated hole 42, has been manufactured by forming material powder by powder press method or injection molding method, followed by firing.

Japanese Patent Application Laid-Open No. 2001-179968 discloses an alumina sintered body that contains Al₂O₃ having a content of 96 to 99.8%, and three components of SiO₂, CaO and MgO, as an insulting ceramic substrate used for ink chambers of an ink jet recording head structure that utilizes deformation of piezoelectric elements. With use of this alumina sintered body, the elution of glass composition in the alumina sintered body can be suppressed even if exposed to ink, thereby avoiding the increased ink viscosity and the coagulation of pigment in the ink.

As ink for an ink jet recording head structure, demands for non-solvent type ink is increasing in order to take into consideration environmental issues of the recent concern and the like. However, the non-solvent type ink has poor dispersibility of pigment. Therefore, there has been used, one whose dispersibility of pigment is improved by bringing ink to strongly alkaline (pH 10 to 12).

Unfortunately, one in which an alumina sintered body is used in part of the surface exposed to ink, for example, as the case with the ink jet recording head structure 31 shown in FIG. 7, suffers from the following problem. If exposed to the above-mentioned strongly alkaline ink for a long period of time, the glass component in the alumina sintered body elutes and deposits in the ink, so that the ink viscosity is increased and the pigment in the ink condenses thereby to produce rough portions and dense portions. As a result, the dimension of ink droplets is unstable and there occurs variations in dot, thus affecting printed image.

Japanese Patent Application Laid-Open No. 2001-179968 also describes to use a dense alumina sintered body that contains Al₂O₃ in a content of 96 to 99.8% and having a bulk specific gravity of 3.7 or more. However, with the support member having a complicated three-dimensional structure, it is difficult to make the entire body into a uniform and dense structure, thus causing variations in open pores (voids). In many cases, the surface open porosity is large, or open pores are partially large. With such a support member, the strongly alkaline ink is liable to enter the inside of ceramics, and it is extremely disadvantageous to chemical elution and falling of grains

Furthermore, in the ink jet recording head structure 31 utilizing the thermal energy of the heat generating resistor 35 as a pressurizing mechanism, if the temperature of the heat generating resistor 35 is momentarily elevated to a temperature of several hundreds degrees C., this causes the problem of cogation in which the pyrolytic products of ink components and the like deposit on the surface of the heat generating resistor 35. If, at the same time, Si, Mg and Ca components that are the glass components in the alumina sintered body are eluted in a large amount, glass deposit often occurs on the surface of the heat generating resistor 35. This deposit contributes to inhibition of the thermal conduction from the heat generating resistor 35 to the ink, and no ordinal ink bubbling is generated. As a result, a defect occurs in printing in some cases. In order to increase the durability of the ink jet recording head structure 31, it is required to reduce the deposit onto the surface of the above-mentioned heat generating resistor 35.

Along with high precision of image quality, one provided with an ink discharge hole 38 having a small pore diameter has been used. However, machining chips, dust and the like exist in pores and recess portions that are opened to the elongated hole 42, the inclined bottom surface 43, and small-diameter hole 44 of the above-mentioned support member 40. These machining chips, dust and the like cannot completely be removed even by cleaning process. Therefore, if used in this state, there is the possibility that when ink is supplied to the ink delivery hole 41, the machining chips, dust, etc. existing in the pores and the recess portions, which are opened to the surface to be exposed to ink, flows together with the ink and clog the ink discharge hole 38 having a small pore diameter.

As in the ink recording head disclosed in Japanese Patent Application Laid-Open No. 2001-179968, laser beam machining is employed to form an ink discharge hole in an insulating ceramic substrate composed of an alumina sintered body. When the ink discharge hole is formed in the alumina sintered body by laser beam machining, fume composed of glass component swelling like burr is formed in the periphery of the ink discharge hole. If this fume is exposed to strongly alkaline ink and then corroded, it falls in the ink and clogs the fine ink discharge hole, thereby inhibiting discharge of ink droplets.

Along with high printing speed and high image quality at the same time, there is a tendency of high density of an ink discharge hole and short printing cycle. Especially, in the ink jet recording head structure 31 using the thermal energy of the heat generating resistor as shown in FIG. 7, the heat generating resistor 35 is also arranged at high density in response to high density of the ink discharge hole 38. Therefore, when printing cycle is shortened, the thermal energy from the heat generating resistor 35 is increased thereby to increase the temperature within the ink chamber 34. As a result, ink bubbling action is changed to cause variations in printing. It is therefore required to shorten printing cycle by increasing radiating property in the vicinity of the ink chamber 34.

In general, when the temperature of ink is increased, ink viscosity is changed and it appears as non-uniformity of image density. To avoid this, the time of printing cycle is controlled such that the temperature of ink is not above 60° C., at which ink viscosity change is initiated. When the temperature of ink reaches 60° C., there is a tendency of considerably accelerating corrosion and elution of glass component from an alumina sintered body exposed to strongly alkaline ink.

### SUMMARY OF THE INVENTION

The present invention aims at solving the above-mentioned problems. Specifically, an alumina sintered body of the present invention includes not less than 99.3% by weight of Al₂O₃, not more than 0.25% by weight of SiO₂, not more than 0.3% by weight of MgO, and not more than 0.3% by weight of CaO, and having an open porosity ratio of less than 5%, and an average open pore diameter of not more than 5 μm. This improves chemical resistance, in particular, alkali resistance.

Accordingly, in the ink jet recording head structure of this invention, at least the surface exposed to ink is composed of the alumina sintered body containing not less than 99.3% by weight of Al₂O₃, not more than 0.25% by weight of SiO₂, not more than 0.3% by weight of MgO, and not more than 0.3% by weight of CaO. The surface open porosity of the above-mentioned alumina sintered body surface is less than 5%, and the average open pore diameter is not more than 5 μm. This eliminates that the glass component in the alumina sintered body elutes into ink due to exposure to strongly alkaline ink for a long period of time, thereby stabilizing ink viscosity.

In accordance with this invention, it is able to provide an ink jet printer capable of printing at high precision.

The alumina sintered body of this invention can be manufactured by charging, in a die, slurry containing Al₂O₃ powder having an average particle diameter of 0.1 to 3.0 μm, and forming in a predetermined shape, followed by firing of the obtained forming body.

A method for manufacturing an ink jet recording head structure of the present invention is a method for manufacturing an ink jet recording head structure having a stepped through hole, and includes the following steps (1) to (6):

(1) the step of inserting part of a stationary punch into a first through hole of a die, and inserting part of a floating punch into a second through hole in the stationary punch so as to form a stepped recess portion by using the die, the stationary punch and the floating punch;

(2) the step of charging ceramic granulated powder comprising mainly Al₂O₃ powder having a mean particle diameter of 0.1 to 3.0 μm, into the above-mentioned stepped recess portion;

(3) the step of raising the above-mentioned floating punch such that a projected portion of the tip thereof projects beyond ceramic material powder, and the step of lowering an upper punch having a recess portion or a third through hole such that the projected portion of the above-mentioned floating punch is fitted in the recess portion or the third through hole of the upper punch;

(4) the step of further lowering the upper punch so as to pressurize the ceramic material powder, and forcedly lowering the above-mentioned floating punch prior to completion of compression;

(5) the step of forming a ceramic forming body having a stepped through hole by lowering the above-mentioned upper punch up to the position of completion of compression after the floating punch is lowered; and

(6) the step of firing the above-mentioned ceramic forming body.

An ink jet printer of the present invention includes an ink jet recording head consisting of a flow passage member provided with a plurality of ink chambers and heat generating resistors for pressurizing ink disposed in respective ink chambers, and a nozzle plate having ink discharge holes in communication with the respective ink chambers; a support member that supports the ink jet recording head and has ink delivery holes in communication with the ink chambers of the flow passage member; and means for pressurizing the ink in the ink chambers such that ink droplets are discharged from the ink discharge holes so as to print on recording paper by causing the heat generating resistors to develop heat so as to generate bubbles in the ink chambers in a state in which ink is supplied to the ink chambers from the ink delivery holes. Of the above-mentioned flow passage member, the ink jet recording head and the support member, at least the support member is composed of the alumina sintered body as set forth in claim 1.

In addition, since the alumina sintered body has a thermal conductivity of not less than 30 W/mK, printing cycle can be shortened by increasing the radiating property in the vicinity of the ink chambers.

### BRIEF DESCRIPTION OF THE DRAWINGS

FIGS. 1(a) and 1(b) are a perspective view and a partially broken away perspective view, respectively, showing an example of an ink jet recording head structure according to the present invention;

FIGS. 2(a) to 2(c) are exploded perspective views showing the ink jet recording head structure shown in FIGS. 1(a) and 1(b);

FIGS. 3(a) and 3(b) are a perspective view and a partially broken away perspective view of a support member;

FIGS. 4(a) and 4(b) are sectional views taken along the line X-X and the line Y-Y in FIG. 1(a), respectively;

FIGS. 5(a) to 5(d) are sectional views for explaining a forming process in a powder press apparatus;

FIG. 6 is a time chart showing the operations of components in the powder press apparatus; and

FIG. 7 is a sectional view of a conventional ink jet recording head structure.

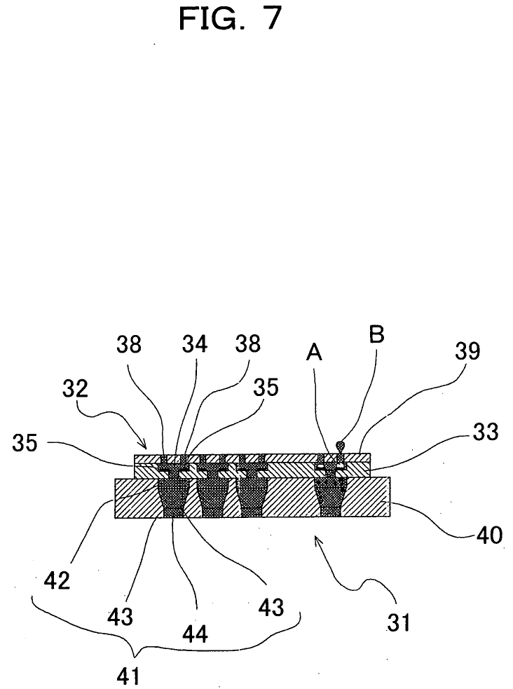

### DESCRIPTION OF PREFERRED MEBODIMENTS

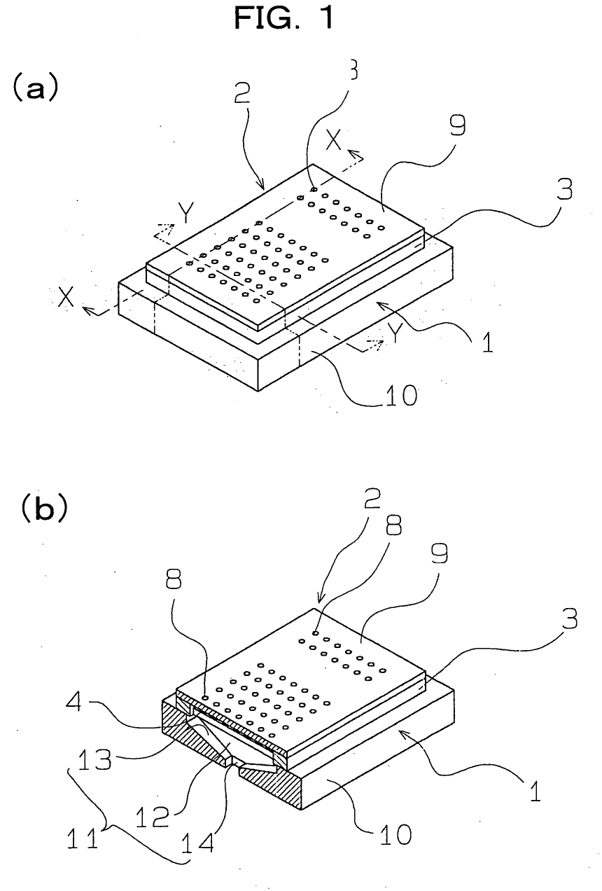

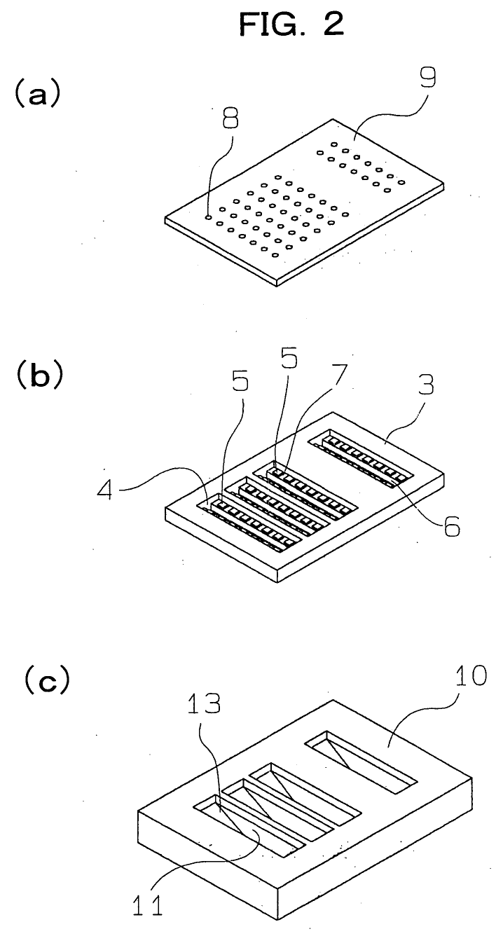

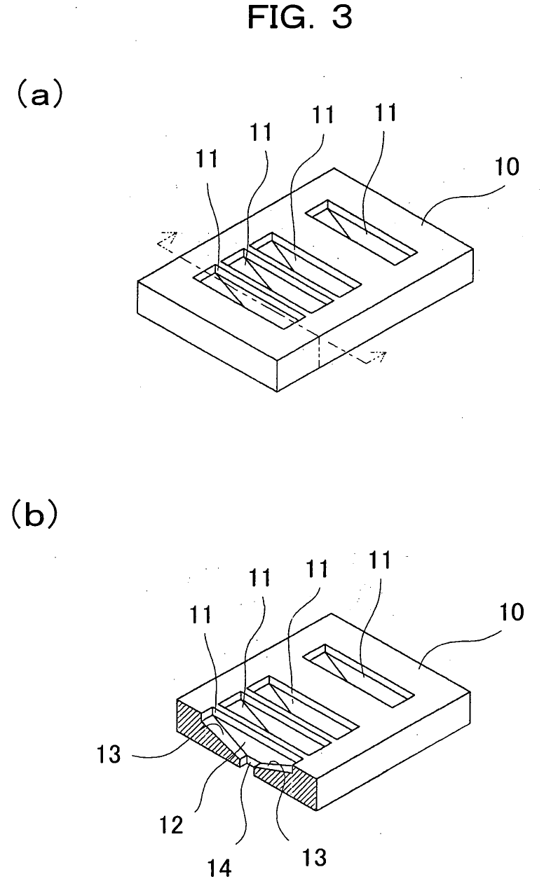

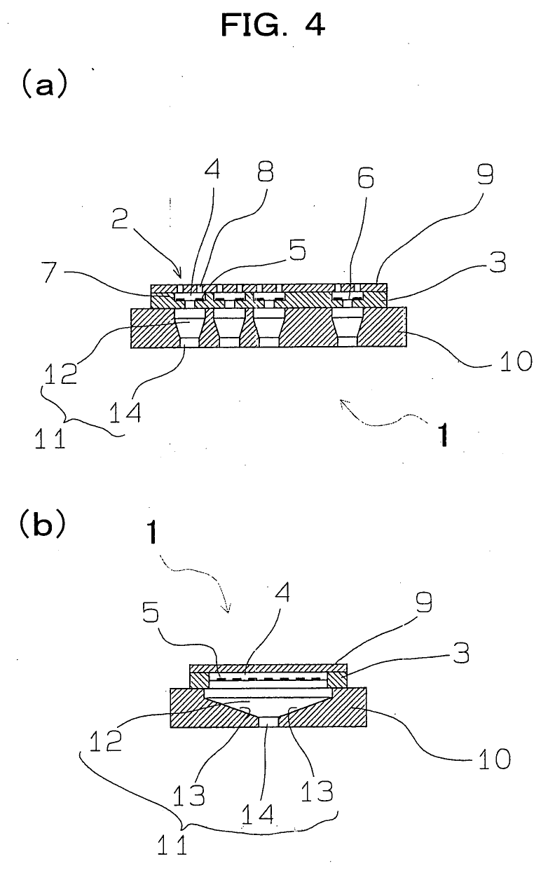

Referring to FIG. 1 to FIG. 4, an ink jet recording head structure 1 comprises a flow passage member 3 having a plurality of ink chambers 4 and heat generating resistors 5 for pressurizing ink disposed in the respective ink chambers 4; an ink jet recording head 2 having a nozzle plate 9 provided with ink discharge holes 8 in communication with the ink chambers 4; and a support member 10 made of ceramics that supports the ink jet recording head 2 and has ink delivery holes 11 in communication with the ink chambers 4 of the flow passage member 3.

The flow passage member 3 constituting the ink jet recording head 2 is formed by, for example, disposing in parallel a plurality of stepped grooves 6 on a silicon substrate. A plurality of heat generating resistors 5 are disposed in parallel at predetermined intervals at a step portion 7 of the stepped grooves 6. The nozzle plate 9 is disposed on the flow passage member 3 such that the ink discharge holes 8 are located at positions opposed to their respective corresponding heat generating resistors 5. The flow passage member 3 may entirely be an alumina sintered body to be described later, or at least the surface exposed to ink may be an alumina sintered body.

The nozzle plate 9 is obtained by, for example, disposing a plurality of the ink discharge holes 8 at predetermined intervals on a plate-like photosensitive resin. The nozzle plate 9 may entirely be an alumina sintered body to be described later, or at least the surface exposed to ink may be an alumina sintered body.

An alumina sintered body of the present invention is particularly excellent in chemical resistance among ceramics, and therefore has the characteristic feature of being unsusceptible to corrosion even if exposed to strongly alkaline ink. Furthermore, because of high thermal conductivity, the radiating property in the vicinity of the ink chambers 4 can be increased to shorten printing cycle.

When the pixel number to be printed is 300 dpi, the ink discharge holes 8 may be of approximately 30 μm. For use of high image-quality printing, the ink discharge holes 8 are preferably in the range of 5 to 25 μm. The reason for this is that under approximately 300 dpi, the droplet particles condition on a printing surface can be confirmed by visual observation, thus causing a significant image quality difference with silver photograph. In addition, since in the ink jet printer, the gradation of the density of the same color is represented by the compression of droplet particles, fine droplet particles produce clear printing.

The pore diameter of the ink discharge holes 8 is determined depending on the required pixel number. Therefore, the average crystal particle diameter of an alumina sintered body used for the ink jet recording head structure 1 may be determined according to the pixel number. That is, as the pore diameter of the ink discharge holes 8 is smaller, the average crystal particle diameter of an alumina sintered body to be used may be smaller, thereby enabling to suppress clogging.

The support member 10 is obtained by punching, in a plate-like alumina sintered body, a plurality of the ink delivery holes 11 in communication with the respective ink chambers 4 of the ink jet recording head 2. The respective ink delivery holes 11 consist of an elongated hole 12 having an inclined bottom surface 13, which is opened on the ink jet recording head 2 side and further deepened toward the center, and a small-diameter hole 14 that is opened on the side opposite to the ink jet recording head 2 and communicated with the elongated hole 12.

Printing on recording paper by use of the ink jet recording head structure 1 is performed as follows. In a state in which ink is supplied from the ink delivery holes 11 to the ink chambers 4, the heat generating resistors 5 are caused to develop heat so as to generate bubbles in the ink chambers 4, thereby pressurizing the ink in the ink chambers 4, so that ink droplets are discharged through the ink discharge holes 8 to recording paper.

At least the surfaces of the support member 10, the nozzle plate 9 and the flow passage member 3 which are exposed to ink are formed by an alumina sintered body containing not less than 99.3% by weight of Al₂O₃, not more than 0.25% by weight of SiO₂, not more than 0.3% by weight of MgO, and not more than 0.3% by weight of CaO. Thus, since the glass component amounts of SiO₂, MgO and CaO are small, even if the glass component is eluted due to exposure to strongly alkaline ink, the eluted amount thereof is extremely small. As a result, the amount of hydroxide to be reacted with ink is small, thereby suppressing an increase in ink viscosity and also lowering the percentage at which the pigment in ink coagulate.

For this, the size of ink droplets discharged through the ink discharge holes 8 are stabilized to prevent variations in dot, thereby permitting to print high quality image at high precision.

Furthermore, in the above-mentioned alumina sintered body, the surface open porosity of at least the surface exposed to ink is less than 5%, and the average open pore diameter is not more than 5 μm. This further reduces the elution of glass component from the surface exposed to ink. Specifically, when the surface open porosity is not less than 5%, the surface area exposed to strongly alkaline ink is increased thereby to increase the elution of glass component and the falling of component particles thereof. Particularly, when the average open pore diameter exceeds 5 μm, particles greater than 5 μm fall from the inside of the open pores, which contribute to the nozzle clogging of the ink discharge holes. The occurrence of the nozzle clogging in the ink discharge holes 8 can be suppressed by controlling the surface open porosity and the average open pore diameter so as to minimize particles falling from the inside of the open pores.

The surface exposed to ink in the alumina sintered body preferably has a surface open pore standard deviation of not more than 1.0. If the surface open pore standard deviation is over 1.0, there occur variations in open pores, resulting in the presence of open pores having a large pore diameter. Therefore, if such open pores are exposed to strongly alkaline ink, the size of falling particles is increased so that the nozzle clogging of the ink discharge holes 8 is liable to occur.

The chemical reaction between strongly alkaline ink and SiO₂, MgO and CaO varies depending on the temperature of ink. Under environment that the temperature of ink is 20° C. to 60° C., the sum of Si, Mg and Ca that are eluted from the surface exposed to ink is preferably not more than 0.1 ppm/(cm²·day).

This minimizes the elution of Si, Mg and Ca components, which are glass components in the alumina sintered body, into ink. As a result, no glass deposit exists on the surface of the heat generating resistors, thus leading to a longer life of the ink jet recording head structure.

Additionally, by limiting the elution amount of Si, Mg and Ca, the agglutination of glass component or the agglutination of alumina particles and glass component, which may occur in the periphery of the ink delivery holes of the support member, can be suppressed thereby to suppress the nozzle clogging of the ink discharge holes 8.

The sum of the elution amount of Si, Mg and Ca was found in the following manner. The support member was placed in strongly alkaline (pH 12) ink at a water temperature of 20° C., and left to stand three days. The obtained ink solution was subjected to quantitative analysis of Ca, Si and Mg, with use of an ICP emission spectrometry device (Model JY38P2, manufactured by Seiko Denshi Kogyo Co., Ltd.).

The average crystal particle diameter of an alumina sintered body is preferably 1.0 to 10.0 μm. When the average crystal particle diameter is not more than 10.0 μm, even if the falling of particles occurs along with the elusion of the glass component of the alumina sintered body, the nozzle clogging of the ink discharge holes 8 due to the falling of particles is avoidable. In order to improve corrosion resistance to strongly alkaline ink, it is effective to minimize the mean particle diameter of the alumina sintered body. This however causes the problem that machining rate cannot be raised in the process of grinding after firing, and the like. Accordingly, the average crystal particle diameter is preferably not less than 1.0 μm.

More preferable average crystal particle diameter of the alumina sintered body is 3.0 to 9.0 μm, most preferably 5.0 to 8.0 μm. Since the crystal particle diameter can be made small, the clogging of ink discharge holes can be suppressed even if the falling of particles occurs. The average crystal particle diameter can be found from intercept method.

The content of MgO in the above-mentioned alumina sintered body is preferably 30.0 to 80.0% by weight in the composition ratio of three components of SiO₂, MgO and CaO. When the content of MgO in the composition ratio of the three components is less than 30.0% by weight, abnormal particle growth occurs during firing, and a discharge hole through which such abnormal grains fall might cause clogging. When it is over 80.0% by weight, corrosion resistance to ink might be lowered.

The apparent density of the above-mentioned alumina sintered body is preferably not less than 3.90×10³ kg/m³. In other words, when the apparent density is not less than 3.90×10³ kg/m³, the volume of open pores in the surface of the alumina sintered body is reduced. Accordingly, the area exposed to strongly alkaline ink is reduced thereby to improve corrosion resistance. From the viewpoint of improvement of corrosion resistance, the apparent density of not less than 3.90×10³ kg/m³ is especially preferable. The apparent density is evaluated according to JIS C 2141.

The following is a method for manufacturing an alumina sintered body of the present invention by injection molding. To not less than 99.3% by weight of Al₂O₃ powder having a mean particle diameter of 0.1 to 3.0 μm, not more than 0.25% by weight of SiO₂, not more than 0.3% by weight of MgO, and not more than 0.3% by weight of CaO are added as sintered additive.

The obtained material and organic material such as thermoplastic resin, lubricant and plasticizer are kneaded while heating, to obtain a forming material. This material is then purified and formed by injection molding. First, the forming material is heated by a heater. The material melted and plasticized by snear stress of a screw in a molding machine is poured in a cavity. An occurrence of burn-off is eliminated by retaining pressure even after pouring the material, and supplying the amount of the material corresponding to shrinkage occurred during cooling, and preventing the reverse flow of the material within the cavity. At the point of time that the formed product is cooled, the die is opened and the formed product is taken out.

Subsequently, a degreasing process is performed, followed by firing in an oxidizing atmosphere at 1500 to 1800° C., preferably 1600 to 1750° C., thereby obtaining a dense alumina sintered body.

The following is a method for manufacturing the support member 10 composed of an alumina sintered body of the present invention by use of powder press method. First, to not less than 99.3% by weight of Al₂O₃ powder having a mean particle diameter of 0.1 to 3.0 μm, not more than 0.25% by weight of SiO₂, not more than 0.3% by weight of MgO, and not more than 0.3% by weight of CaO are added as sintered additive. The mixed material is subjected to wet grinding by a mill, and binder serving as forming aid is added and mixed to prepare slurry. The slurry is dried while spraying it in the form of mist by a spray dryer, thereby obtaining granulated powder having a uniform spherical shape.

By powder press method provided with a step pressing structure, the obtained powder particles is formed in the shape of the support member 10, and then fired in an oxidizing atmosphere at a firing temperature of 1500 to 1800° C., thereby forming an alumina sintered body that contains not less than 99.3% by weight of Al₂O₃, not more than 0.25% by weight of SiO₂, not more than 0.3% by weight of MgO, and not more than 0.3% by weight of CaO, and has a surface open porosity ratio of less than 5% and an average open pore diameter of not more than 5 μm.

Specifically, forming the shape of the support member 10 by the powder press method provided with the step pressing structure is important for suppressing an occurrence of surface open pores in the sintered body surface. That is, the forming density of the support member 10 can be uniformed and, at the same time, an occurrence of cracks in the forming body can be prevented to form a high accuracy shape, by preparing a die punch integrating the shape of the ink delivery holes 11, and having this die punch to be controlled as a floating punch, independently of a stationary punch, and pressurizing the floating punch after forcedly and slightly lowering it immediately before the completion of compression of the forming body.

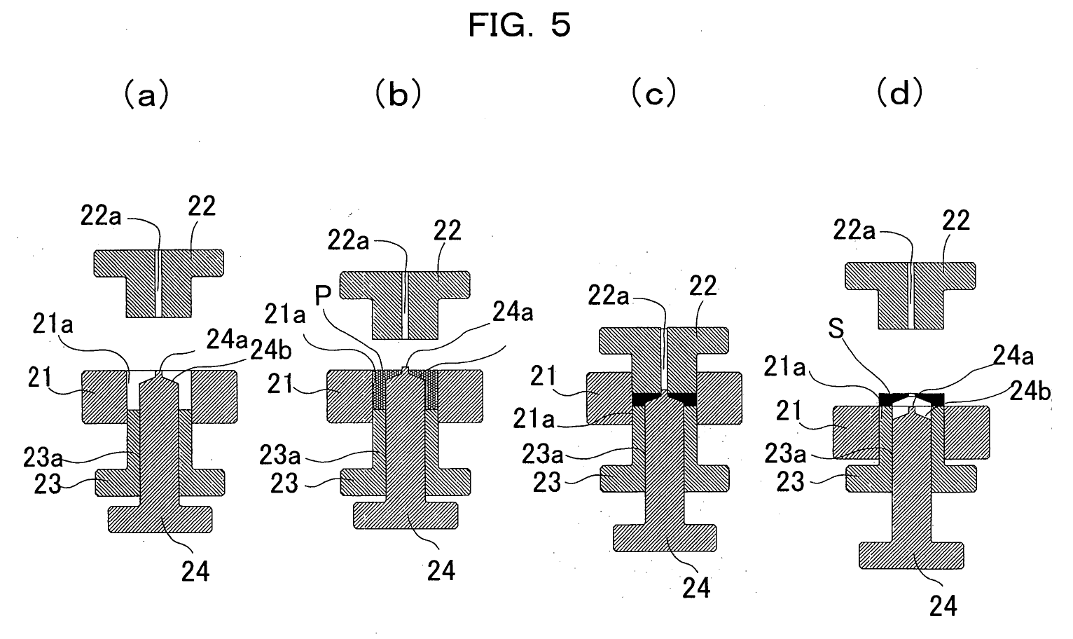

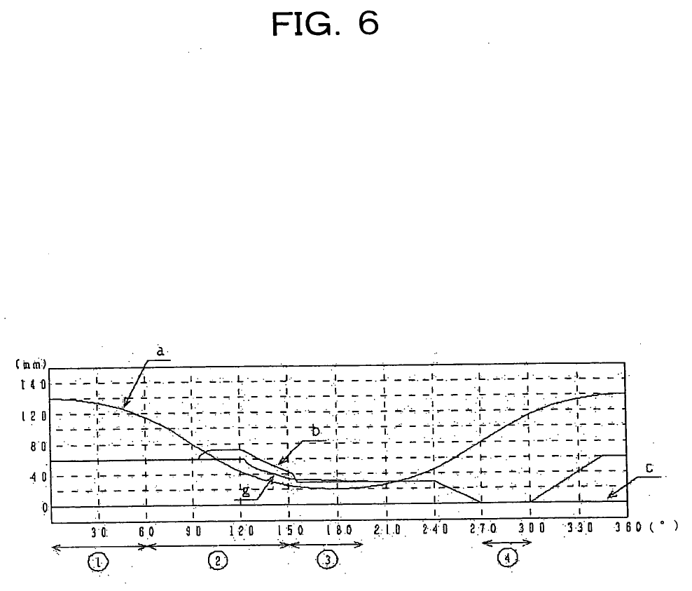

The powder press method provided with the step pressing structure is now described with reference to FIG. 5 and FIG. 6. FIGS. 5(a) to 5(d) are schematic sectional views, which are viewed from a side surface in order to explain a die structure of a powder press apparatus. FIG. 6 is a time chart showing the operation of respective die components of the powder press apparatus.

The powder press apparatus provided with the step pressing structure is used for integrally forming the shape of an elongated hole 12 with an inclined bottom surface 12, such as ink delivery holes 11 of the support member 10, and the shape of a small-diameter hole 14 in communication with the elongated hole 12. As shown in FIG. 5, this apparatus has a die 21, an upper punch 22, a stationary punch 23 and a floating punch 24.

The die 21 functions to form the outline of the support member 10 that becomes a forming body S, and has a first through hole 21. The stationary punch 23 functions to pressurize ceramic material powder and is inserted in a first through hole 21a of the die 21, and has a second through hole 23a. The floating punch 24 functions to form the inside shape of the support member 10 that becomes the forming body S, and is inserted in a second through hole 23a of the stationary punch 23. The floating punch 24 has at its tip a taper surface 24b corresponding to the inclined bottom surface 12 of the support member 10, and a projected portion 24a corresponding to the small-diameter hole 14. Like the stationary punch 23, the upper punch 22 functions to pressurize ceramic granulated powder, and is inserted in the first through hole 21a of the die 21, and has a third through hole 22a, into which the projected portion 24a of the floating punch 24 is inserted.

The above-mentioned die 21, the upper punch 22, the stationary punch 23 and the floating punch 24 are constructed so as to perform a sequence of actions by a rotational axis (not shown). The action of respective components is controlled by the angle of rotation of a cam disposed in the rotational axis.

With use of the powder press apparatus provided with the step pressing structure, a ceramic forming body is formed integrally as follows. Referring to FIG. 5(a), first, in the region \mathring{1} in FIG. 6, part of the stationary punch 23 is inserted in the first through hole 21a formed in the die 21, and part of the floating punch 24 is inserted in the second through hole 23a of the stationary punch 23, and a stepped recess portion P is formed by the die 21, the stationary punch 23 and the floating punch 24.

At this stage, the projected portion 24a of the floating punch 24 is located slightly lower than the upper surface of the die 21, and the upper punch 22 is disposed above the stepped recess portion P.

Subsequently, ceramic granulated powder comprising mainly Al₂O₃ powder having a mean particle diameter of 0.1 to 3.0 μm is supplied to the stepped recess portion P so as to be charged up to the upper surface of the die 21.

The reason why the mean particle diameter of the Al₂O₃ powder is set to 0.1 to 3.0 μm is that with the mean particle diameter of less than 0.1 μm, the pressure during formation is dispersed by the friction of powder, making it difficult to propagate the pressure up to the inside of the forming body. On the other hand, when the mean particle diameter is over 3.0 μm, sinterability deteriorates and it is difficult to obtain a dense sintered body, and the surface open porosity is increased to make a large open pore diameter. The mean particle diameter of Al₂O₃ powder can be found by laser diffraction scattering method.

Referring to FIG. 5(b), in the region \mathring{2} in FIG. 6, the floating punch 24 is slightly raised such that part of the projected portion 24a of the floating punch 24 is projected beyond the upper surface of the ceramic granulated powder. At the same time, the upper punch 22 is started to descend.

Subsequently, the upper punch 24 is further lowered such that the projected portion 24a of the floating punch 24 is inserted in the third through hole 22a of the upper punch 22. Then, the upper punch 22 is gradually lowered such that the ceramic granulated powder is gradually pressurized. At this time, the floating punch 24 is also gradually lowered as the upper punch 22 is lowered.

Referring to FIG. 5(c), when the upper punch 23 is short of the completion of compression (i.e., in short of a bottom dead center), which corresponds to the region \mathring{3} in FIG. 6, the floating punch 24 is forcedly and slightly lowered, and then the upper punch 23 is lowered to the position of completion of compression (the bottom dead center), thereby completing the forming.

Thus, by slightly lowering the floating punch 24 in short of the completion of compression (in short of the bottom dead) of the upper punch 23 and further lowering to the position of completion of compression (the bottom dead center) of the upper punch 23, the ceramic granulated powder in the periphery of the inclined bottom surface 13 of the support member 10 is fluidized thereby to improve filling of the ceramic granulated powder. This enables to uniform the entire forming density of the ceramic forming body S that becomes the support member 10 having a complicated shape.

Referring to FIG. 5(d), in the region \mathring{4} in FIG. 6, the upper punch 23 is then raised and the die 21 is lowered so that the ceramic forming body S is taken out.

With the above-mentioned powder press method provided with the step pressing structure, even if the ceramic forming body S is pressured at a forming pressure of 80 to 150 MPa, an occurrence of cracks in the ceramic forming body S is avoidable, leading to the result that the surface open porosity of the surface of the sintered body fired at a temperature of 1500 to 1650° C. is less than 5%, and the average open pore diameter is not more than 5 μm.

The reason why the forming pressure is set to 80 to 150 MPa is that under the pressure of not more than 80 MPa, the ceramic granulated powder has poor filling, making it difficult to obtain a dense sintered body. If the sintered body is not dense, the surface open porosity is high and the open pore diameter is increased. Due to attack by ink, the elution of glass component occurs, which cause the problem of falling of grains. On the other hand, under the pressure exceeding 150 MPa, especially the support member 10 having a complicated three-dimensional structure has the disadvantage that the forming body causes lamination cracks and the like.

In order to prevent the glass component from being attacked by ink, it can be considered to increase the purity of Al₂O₃ powder in the alumina sintered body. By increasing the purity of the Al₂O₃ powder, the proportion of SiO₂, MgO and CaO, each sintered additive, is lowered to degrade sinterability. To compensate this, the specific surface area of the Al₂O₃ powder is increased thereby to improve the activity of sintering. Therefore, the specific surface area of the Al₂O₃ powder is preferably 0.5×103 to 15.0×10³ m²/kg.

When the specific surface area is greater than 15.0×10³ m²/kg, a primary particle diameter of Al₂O₃ powder is too small and pressure transmission is dispersed. This makes it difficult to obtain a dense forming body, failing to obtain a dense sintered body. On the other hand, when the specific surface area is smaller than 0.5×10³ m²/kg, the activity of sintering is lowered, making it difficult to obtain a dense sintered body. The specific surface area of Al₂O₃ powder can be obtained according to JIS R1626.

Since the ceramic forming body formed by the powder press method is fired at a low temperature of 1550 to 1650° C., the crystal particle diameter can be made small. Thereby, if the falling of grains occurs, the clogging of the ink discharge holes can be suppressed.

In addition, by use of the powder press method provided with the above-mentioned step pressing structure, even such a shape having the stepped recess portion P and variations in the member thickness, as in the support member 10, variations in the forming density can be suppressed to permit high precision manufacturing.

Subsequently, a face to be set, after sintering, to the ink jet recording head 2 of the support member 10, and a face to be set to an ink tank (not shown) are ground by a diamond wheel, such that their respective flatness is maintained within 2.0 μm. By ultrasonic cleaning, oil contamination, grinding fluid and grinding waste are removed to manufacture the support member 10.

The support member 10 composed of the alumina sintered body so obtained can have an entire apparent density of 3.9 or more, a Young's modulus of 300 GPa or more, a thermal conductivity of 30 W/mK or more, and a coefficient of linear expansion of 7.5×10⁻⁶ 1/° C. or less. These characteristic values can be found as follows. The apparent density is measured by Archimedes method. The Young's modulus is obtained by ultrasonic pulse method. The thermal conductivity is measured by laser flash method using an alumina sintered body machined in Φ 10 mm×1.5 mm.

With use of an ink jet printer on which the ink jet recording head structure 1 of the present invention is mounted, when the ink jet recording head is fixed, pattern printing is performed at 120 to 180 dpi, and the positions of printed dots after printing are measured by an image measuring apparatus. As a result, the point of impact of ink droplets can be controlled in the range of ±10 μm, permitting high precision printing.

While the preferred embodiments of the present invention have been described, the present invention should not be limited to the foregoing preferred embodiments, and is, of course, applicable to embodiments in which changes and modifications are made without departing from the gist of the present invention.

### EXAMPLES

### Example 1

Experiments were conducted to examine an alumina sintered body suitable for forming a support member of an ink jet recording head structure and the surface condition thereof, in particular, open porosity and open pore diameter.

To a 99.5% by weight of Al₂O₃, SiO₂, MgO and CaO were added and mixed as sintered additive. To this mixture, organic binder and solvent were added to prepare slurry. By injection forming method, this is formed and fired at a temperature indicated in Table 1, thereby preparing a support member 10 composed of an alumina sintered body. The sintered additives were set, in the composition ratio of three components of SiO₂, MgO and CaO, to 30% by weight of SiO₂, 40% by weight of MgO, and 30% by weight of CaO.

The surface in the vicinity of the center of an inclined bottom surface 12 of the obtained support member 10 was removed 0.1 mm by grinding, and subjected to mirror finish of not more than 0.1 μm in Ra. Thereafter, image of a metallographic microscope was captured with a CCD camera. With use of LUZEX image analysis, twenty measurements in total were made under the conditions of a magnification of ×200 and a measuring area of 2.25×10⁻² mm², in order to examine the surface open porosity and the mean open pore diameter.

The support member was placed in strongly alkaline ink of pH 12 at a water temperature of 20° C., and left to stand three days. The respective amounts of Ca, Si and Mg in the ink solution were measured by quantitative analysis with an ICP emission spectrometry device (Model JY38P2, manufactured by Seiko Denshi Kogyo Co., Ltd.). Then, after filtering the ink solution, an SEM photograph was taken at a magnification of ×500, and the presence and the absence of falling granulated material, and the maximum size of the falling granulated material were confirmed. After being subjected to gold deposition for specifying the falling granulated material, qualitative analysis was conducted by energy dispersive X-ray analyzer (EDS).

The sum of glass elution amounts of Si, Mg and Ca, which were found from the quantitative analysis with the ICP emission spectrometry device, was evaluated as follows. Sample of 0.1 ppm/(cm²·day) or less was judged as suitable and indicated by symbol “⊚”. Sample of not less than 0.1 ppm/(cm²·day) and less than 0.14 ppm/(cm²·day) was judged as good and indicated by symbol “∘”. Sample of not less than 0.14 ppm/(cm²·day) and less than 0.20 ppm/(cm²·day) was judged as no good and indicated by symbol “Δ”. Sample of not less than 0.20 ppm/(cm²·day) was judged as unsuitable and indicated by symbol “X”. Table 1 shows the results.

TABLE 1

| | | Surface Open | | Strongly Alkaline Ink Evaluation | | |
|---|---|---|---|---|---|---|
| | | Pore Condition | | | Falling | |
| | Firing | Open | Open Pore | Glass Elution | Granulated | |
| Sample | Temperature | Porosity | Diameter | Amount | Material | |
| No. | (° C.) | (%) | (μm) | (ppm) | (μm) | Evaluation |
| *1 | 1530 | 5.4 | 5.2 | 0.15 | 5.5 | X |
| 2 | 1580 | 4.9 | 4.9 | 0.12 | 5.2 | Δ |
| 3 | 1600 | 3.8 | 3.8 | 0.10 | 3.8 | ⊚ |
| 4 | 1630 | 3.1 | 3.0 | 0.09 | 2.9 | ⊚ |
| 5 | 1650 | 2.3 | 2.5 | 0.08 | 2.7 | ⊚ |
| 6 | 1700 | 2.1 | 2.4 | 0.07 | 2.0 | ⊚ |
| 7 | 1750 | 2.5 | 2.6 | 0.08 | 2.3 | ⊚ |
| 8 | 1800 | 3.9 | 3.7 | 0.11 | 4.0 | ◯ |

Sample numbers marked with * are not within the scope of the present invention.

From Table 1, it is apparent that the alumina sintered body having a surface open porosity of 5% or less and an average open pore diameter of 5 μm or less is excellent in alkali resistance.

### Example 2

By using SiO2, MgO and CaO as sintered additive and changing the content of Al₂O₃ in the range of 96.0 to 99.9% by weight, granulated powder was prepared and formed at a forming pressure of 100 MPa by powder press method provided with a step pressing structure. This was then fired at a temperature of 1650° C., thereby obtaining a support member 10 composed of an alumina sintered body. In the same manner as in Example 1, measurements were made to examine surface open porosity, average open pore diameter, the presence and the absence of falling granulated material, the maximum size and the qualitative analysis of the falling granulated material, glass elution amount, and particle amount.

Further, the support member 10 was immersed in pure water of 1000 ml, and then subjected to ultrasonic cleaning at an output of 50 kHz and 180 W for one minute. Thereafter, a 38 ml of wash water was taken out, and particles remaining in the wash water and having a particle diameter of 2 μm or more was extracted by laser diode light cut-off sensor testing device, and the amount of particles was examined.

The thermal conductivity of each alumina sintered body was examined by laser flash method. Table 2 shows the results.

TABLE 2

| | | | | | Surface Open | | Strongly Alkaline | | | | |
|---|---|---|---|---|---|---|---|---|---|---|---|
| | | | | | Pore Condition | | Ink Evaluation | | | | |
| | Component of | | | | | Open | Glass | Falling | | | |
| | Alumina Sintered Body | | | | Open | Pore | Elution | Granulated | | Amount of | Thermal |
| Sample | Al₂O₃ | SiO₂ | MgO | CaO | Porosity | Diameter | Amount | Material | | Particle | Conductivity |
| No. | (%) | (%) | (%) | (%) | (%) | (μm) | (ppm) | (μm) | Evaluation | (1000 pieces/ml) | (W/m · K) |
| *9 | 96.0 | 1.15 | 1.30 | 1.20 | 7.2 | 6.8 | 0.52 | 24.5 | X | 6.9 | 24.0 |
| *10 | 97.0 | 0.85 | 0.95 | 0.95 | 7.1 | 6.5 | 0.34 | 22.4 | X | 5.4 | 25.7 |
| *11 | 98.0 | 0.55 | 0.65 | 0.65 | 7.0 | 6.1 | 0.26 | 21.3 | X | 5.0 | 27.4 |
| *12 | 99.0 | 0.25 | 0.35 | 0.35 | 5.8 | 5.3 | 0.16 | 15.7 | Δ | 3.6 | 29.0 |
| *13 | 99.1 | 0.20 | 0.29 | 0.28 | 5.5 | 4.5 | 0.14 | 10.6 | Δ | 3.4 | 29.6 |
| *14 | 99.2 | 0.18 | 0.25 | 0.24 | 5.1 | 3.7 | 0.14 | 8.4 | Δ | 2.6 | 29.9 |
| 15 | 99.3 | 0.15 | 0.25 | 0.20 | 3.6 | 3.1 | 0.10 | 4.2 | ⊚ | 2.2 | 30.8 |
| 16 | 99.4 | 0.13 | 0.23 | 0.13 | 2.8 | 2.8 | 0.10 | 2.5 | ⊚ | 2.1 | 31.4 |
| 17 | 99.5 | 0.10 | 0.20 | 0.10 | 2.1 | 2.4 | 0.08 | 1.0 | ⊚ | 2.1 | 32.0 |
| 18 | 99.6 | 0.06 | 0.17 | 0.07 | 2.0 | 2.2 | 0.07 | 0.6 | ⊚ | 2.1 | 32.5 |
| 19 | 99.7 | 0.03 | 0.13 | 0.04 | 1.8 | 2.1 | 0.05 | 0.6 | ⊚ | 2.1 | 33.0 |
| 20 | 99.8 | 0.01 | 0.10 | 0.01 | 1.5 | 1.8 | 0.03 | 0.5 | ⊚ | 2.0 | 33.5 |
| 21 | 99.9 | 0.01 | 0.07 | 0.01 | 1.2 | 1.5 | 0.02 | 0.3 | ⊚ | 2.0 | 34.0 |

Sample numbers marked with * are not within the scope of the present invention.

As described above, the qualitative analysis of falling granulated material that was eluted due to strongly alkaline ink was carried out with an energy dispersive X-ray analyzer (EDS). As a result, all of the falling granulated materials were found to be alumina material because the peaks of Al and O were detected therein.

As in Samples No. 9 to No. 11 (alumina sintered bodies containing 96.0 to 98.0% by weight of Al₂O₃), when surface open porosity in the surface of the alumina sintered body is over 5%, and the average open pore diameter is also over 5 μm, the elusion amount of Si, Ma, and Ca is large, and large falling granulated materials can be observed. The reason for this seems to be that the matrix of glass material for connecting alumina particles is melted to facilitate falling of grains. Further, the amount of particles is large, and thermal conductivity is also lower than 30 W/mK.

In Samples No. 12 to No. 14 (alumina sintered bodies containing 99.0 to 99.2% by weight of Al₂O₃), the surface open porosity in the surface of the alumina sintered body is over 5%, and the average open pore diameter is also over 5 μm. Therefore, the falling granulated materials are larger than 5 μm, which can contribute to clogging of the nozzle discharge hole.

In Samples No. 15 to No. 21 (alumina sintered bodies containing 99.3 to 99.9% by weight of Al₂O₃), the size of falling granulated material is not more than 5 μm, and it cannot be considered as a direct factor of clogging the nozzle discharge holes. The surface open porosity in the surface of the alumina sintered body is not more than 5%, and the average open pore diameter is not more than 5 μm. Therefore, it can be seen that the amount of particles is small and the thermal conductivity is controlled to not less than 30 W/mK.

### Example 3

A support member 10 composed of an alumina sintered body was manufactured in the same manner as in Example 2, except that in Example 3, forming was carried out under a forming pressure of 100 MPa, 80 MPa, and 60 MPa, respectively, followed by firing at a temperature of 1650° C. The surface condition and the resistance to alkaline ink of this support member 10 were evaluated in the same manner as in Example 2, and surface open pore standard deviation, falling granulated material, and the elusion amount of glass compo nent were examined. Table 3 shows the results.

TABLE 3

| | | | Surface Open Pore | | | Strongly Alkaline | | |
|---|---|---|---|---|---|---|---|---|
| | | | Condition | | | Ink Evaluation | | |
| | Content | | | Open | | Glass | Falling | |
| | of | Forming | Open | Pore | | Elution | Granulated | |
| Sample | Al₂O₃ | Pressure | Porosity | Diameter | Standard | Amount | Material | |
| No. | (%) | (MPa) | (%) | (μm) | Deviation | (ppm) | (μm) | Evaluation |
| *9 | 96.0 | 100 | 7.2 | 6.8 | 2.4 | 0.52 | 24.5 | X |
| *10 | 97.0 | 100 | 7.1 | 6.5 | 1.9 | 0.34 | 22.4 | X |
| *11 | 98.0 | 100 | 7.0 | 6.1 | 1.6 | 0.26 | 21.3 | X |
| *12 | 99.0 | 100 | 5.8 | 5.3 | 1.3 | 0.16 | 15.7 | Δ |
| *12-(2) | | 80 | 6.5 | 5.9 | 1.4 | 0.19 | 18.2 | Δ |
| *12-(3) | | 60 | 9.3 | 6.5 | 1.5 | 0.23 | 22.3 | X |
| *13 | 99.1 | 100 | 5.5 | 4.5 | 1.2 | 0.14 | 10.6 | Δ |
| *13-(2) | | 80 | 6.4 | 5.3 | 1.2 | 0.18 | 17.5 | Δ |
| *13-(3) | | 60 | 8.8 | 6.7 | 1.4 | 0.24 | 23.4 | X |
| *14 | 99.2 | 100 | 5.1 | 3.7 | 1.1 | 0.14 | 8.4 | Δ |
| *14-(2) | | 80 | 6.3 | 4.8 | 1.3 | 0.17 | 18.4 | Δ |
| *14-(3) | | 60 | 8.4 | 5.9 | 1.4 | 0.21 | 20.9 | X |
| 15 | 99.3 | 100 | 3.6 | 3.1 | 1.0 | 0.10 | 4.2 | ⊚ |
| 15-(2) | | 80 | 4.3 | 4.1 | 1.0 | 0.13 | 4.9 | ◯ |
| *15-(3) | | 60 | 7.2 | 5.5 | 1.2 | 0.17 | 12.6 | Δ |
| 16 | 99.4 | 100 | 2.8 | 2.8 | 0.9 | 0.10 | 2.5 | ⊚ |
| 16-(2) | | 80 | 3.9 | 3.9 | 1.1 | 0.12 | 4.7 | ◯ |
| *16-(3) | | 60 | 6.7 | 5.3 | 1.3 | 0.16 | 10.8 | Δ |
| 17 | 99.5 | 100 | 2.1 | 2.4 | 0.9 | 0.08 | 1 | ⊚ |
| 17-(2) | | 80 | 3.3 | 3.7 | 1.1 | 0.12 | 4.5 | ◯ |
| *17-(3) | | 60 | 5.8 | 5.4 | 1.4 | 0.15 | 11.5 | Δ |
| 18 | 99.6 | 100 | 2.0 | 2.2 | 0.9 | 0.07 | 0.6 | ⊚ |
| 18-(2) | | 80 | 3.2 | 3.3 | 1.0 | 0.11 | 3.4 | ◯ |
| *18-(3) | | 60 | 5.5 | 5.2 | 1.2 | 0.14 | 8.6 | Δ |
| 19 | 99.7 | 100 | 1.8 | 2.1 | 0.9 | 0.05 | 0.6 | ⊚ |
| 19-(2) | | 80 | 2.9 | 3.5 | 1.0 | 0.11 | 3.6 | ◯ |
| *19-(3) | | 60 | 5.1 | 4.9 | 1.2 | 0.14 | 7.1 | Δ |
| 20 | 99.8 | 100 | 1.5 | 1.8 | 0.9 | 0.03 | 0.5 | ⊚ |
| 20-(2) | | 80 | 2.7 | 2.9 | 1.0 | 0.07 | 3.3 | ⊚ |
| 20-(3) | | 60 | 4.8 | 4.7 | 1.1 | 0.12 | 4.8 | ◯ |
| 21 | 99.9 | 100 | 1.2 | 1.5 | 0.9 | 0.02 | 0.3 | ⊚ |
| 21-(2) | | 80 | 2.3 | 2.6 | 1.0 | 0.06 | 3.3 | ⊚ |
| 21-(3) | | 60 | 4.4 | 4.3 | 1.1 | 0.11 | 4.8 | ◯ |

Sample numbers marked with * are not within the scope of the present invention.

As apparent from Table 3, when forming pressure is lowered, the collapsibility of granulated powder is lowered to cause a large vacancy, thereby increasing surface open porosity and average open pore diameter.

In Samples No. 15-(3), No. 16-(3), No. 17-(3), No. 18-(3), and No. 19-(3), the surface open porosity of which is greater than 5%, the elution amount of glass component of Si, Mg and Ca is greater than 0.1 ppm/ (cm²·day) due to attack by strongly alkaline ink.

This shows that the elusion amount of glass component due to exposure to strongly alkaline ink cannot be suppressed only by forming an alumina sintered body from a composition of not less than 99.3% by weight of Al₂O₃, not more than 0.25% by weight of SiO₂, not more than 0.3% by weight of MgO, and not more than 0.3% by weight of CaO; and that it is important to control the surface open porosity of the surface exposed to ink to not more than 5%, and control the average open pore diameter to not more than 5 μm.

### Example 4

The alumina sintered body manufactured in Example 2 was placed in strongly alkaline ink of pH 12 under ink temperature conditions of 40° C. and 60° C., respectively, and left to stand three days. Thereafter, the elution amount of glass component of Si, Mg and Ca in the ink solution was examined with the ICP emission spectrometry device. Measuring condition was the same as in Example 1. Table 4 shows the results.

TABLE 4

| | | | Strongly Alkaline Ink Evaluation | | |
|---|---|---|---|---|---|
| | Content | | Glass | Falling | |
| | of | Ink | Elution | Granulated | |
| | Al₂O₃ | Temperature | Amount | Material | |
| Sample No. | (%) | (° C.) | (ppm) | (μm) | Evaluation |
| *9 | 96.0 | 20 | 0.52 | 24.5 | X |
| | | 40 | 0.67 | 26.3 | X |
| | | 60 | 0.83 | 25.4 | X |
| *10 | 97.0 | 20 | 0.34 | 22.4 | X |
| | | 40 | 0.41 | 23.8 | X |
| | | 60 | 0.45 | 27.9 | X |
| *11 | 98.0 | 20 | 0.26 | 21.3 | X |
| | | 40 | 0.35 | 26.4 | X |
| | | 60 | 0.44 | 21.3 | X |
| *12 | 99.0 | 20 | 0.16 | 15.7 | Δ |
| | | 40 | 0.22 | 27.5 | X |
| | | 60 | 0.23 | 29.5 | X |
| *13 | 99.1 | 20 | 0.14 | 10.6 | Δ |
| | | 40 | 0.17 | 17.8 | Δ |
| | | 60 | 0.21 | 16.4 | X |
| *14 | 99.2 | 20 | 0.14 | 8.4 | Δ |
| | | 40 | 0.18 | 14.4 | Δ |
| | | 60 | 0.23 | 10.8 | X |
| 15 | 99.3 | 20 | 0.10 | 4.2 | ⊚ |
| | | 40 | 0.12 | 4.7 | ◯ |
| | | 60 | 0.13 | 4.9 | ◯ |
| 16 | 99.4 | 20 | 0.10 | 2.5 | ⊚ |
| | | 40 | 0.12 | 2.3 | ◯ |
| | | 60 | 0.13 | 3.0 | ◯ |
| 17 | 99.5 | 20 | 0.08 | 1.0 | ⊚ |
| | | 40 | 0.09 | 1.4 | ⊚ |
| | | 60 | 0.12 | 3.7 | ◯ |
| 18 | 99.6 | 20 | 0.07 | 0.6 | ⊚ |
| | | 40 | 0.08 | 0.8 | ⊚ |
| | | 60 | 0.09 | 1.7 | ⊚ |
| 19 | 99.7 | 20 | 0.05 | 0.6 | ⊚ |
| | | 40 | 0.06 | 0.9 | ⊚ |
| | | 60 | 0.07 | 2.2 | ⊚ |
| 20 | 99.8 | 20 | 0.03 | 0.5 | ⊚ |
| | | 40 | 0.05 | 0.7 | ⊚ |
| | | 60 | 0.06 | 2.1 | ⊚ |
| 21 | 99.9 | 20 | 0.02 | 0.3 | ⊚ |
| | | 40 | 0.03 | 0.2 | ⊚ |
| | | 60 | 0.04 | 0.8 | ⊚ |

Sample numbers marked with * are not within the scope of the present invention.

From the result in Table 4, in Samples No. 9 to No. 14 (alumina sintered bodies containing 96.0 to 99.2% by weight of Al₂O₃), at any ink temperature of 20° C. to 60° C., the elution amount of glass component of Si, Mg and Ca is greater than 0.1 ppm/(cm²·day), and the falling granulated material has a size greater than 5 μm. This can contribute to clogging of nozzle discharge holes.

In Samples No. 15 to No. 21 (alumina sintered bodies containing 99.3 to 99.9% by weight of Al₂O₃), at any ink temperature of 20° C. to 60° C., the elution amount of glass component of Si, Mg and Ca is not more than 0.1 ppm/(cm²·day), and the falling granulated material is not greater than 5 μm. This cannot directly contribute to clogging of nozzle discharge holes.

### Example 5

Examinations were made of an alumina sintered body suitable for forming a support member of an ink jet recording head structure and the surface condition thereof, in particular, surface open pore standard deviation.

A support member 10 was manufactured by using granulated powder of the same composition as Sample No. 17 in Example 2. In the same method for manufacturing a support member 10 as in Example 1, an alumina sintered body of the support member 10 was obtained by firing at a temperature of 1530 to 1750° C.

Evaluations of surface condition and resistance to alkaline ink were conducted in the same manner as in Example 1, and surface open pore standard deviation, falling granulated material, and the elution amount of glass component were examined. Table 5 shows the results. Apparent density was measured according to JIS C2141.

TABLE 5

| | | | | | | Strongly Alkaline Ink | |
|---|---|---|---|---|---|---|---|
| | | | Surface Open Pore | | | Evaluation | |
| | | | Condition | | | | Falling |
| | Firing | Apparent | Open | Open Pore | | Glass Elution | Granulated |
| Sample | Temperature | Density | Porosity | Diameter | Standard | Amount | Material |
| No. | (° C.) | (kg/m³) | (%) | (μm) | Deviation | (ppm) | (μm) |
| 21 | 1530 | 3.88 × 10³ | 4.9 | 5.0 | 1.1 | 0.13 | 4.8 |
| 22 | 1550 | 3.90 × 10³ | 4.9 | 4.8 | 1.0 | 0.10 | 4.5 |
| 23 | 1580 | 3.92 × 10³ | 3.5 | 4.1 | 1.0 | 0.10 | 4.2 |
| 24 | 1600 | 3.94 × 10³ | 2.3 | 2.5 | 0.8 | 0.08 | 4.1 |
| 25 | 1650 | 3.94 × 10³ | 2.1 | 2.4 | 0.9 | 0.08 | 2.3 |
| 26 | 1700 | 3.94 × 10³ | 1.8 | 2.0 | 0.9 | 0.07 | 2.3 |
| 27 | 1750 | 3.94 × 10³ | 1.5 | 1.8 | 0.9 | 0.05 | 2.1 |

As apparent from Table 5, as in Sample No. 21, the alumina sintered body of which surface open pore standard deviation is over 1.0, the glass elution amount exceeds 0.1 ppm. In contrast, it can be seen that when the surface open pore standard deviation is not more than 1.0, the glass elution amount is not more than 0.1 ppm.

This is because Sample No. 21 failed to have dense sintering and caused large variations in surface open pore diameter, so that the open pore surface area of particles increased and therefore the area exposed to ink increased. Additionally, when the surface open pore standard deviation is large, the diameter of falling particles is large. This facilitates clogging of discharge holes.

Further in Sample 21, the apparent density is smaller than 3.90×10³ kg/m³, and the glass elution amount exceeds 0.1 ppm. In contrast, as in Samples Nos. 22-27, when the apparent density is not less than 3.90×10³ kg/m³, the glass elution amount is not more than 0.1 ppm. Especially, when it is not less than 3.94×10³ kg/m³, the glass elution amount can be reduced to 0.08 ppm. The reason for this seems that the increased apparent density reduces the open pore volume of the alumina sintered body surface, thereby reducing the area exposed to strongly alkaline ink.

### Example 6

Experiments were conducted to examine the average crystal particle diameter and the apparent density of an alumina sintered body forming a support member of an ink jet recording head structure. That is, a support member 10 composed of an alumina sintered body was manufactured in the same manner as in Example 2, except that to a Al₂O₃, SiO₂, MgO and CaO were used at a ratio indicated in Table 6. The surface condition and the alkali resistance of the obtained support member 10 were evaluated in the same manner as in Example 1. Table 6 shows the results.

TABLE 6

| | Component | | | | | | | | | | | | |
|---|---|---|---|---|---|---|---|---|---|---|---|---|---|
| | of Alumina | | | | | | | Surface Open Pore | | | Strongly Alkaline | | |
| | Sintered Body | | | | | | | Condition | | | Ink Evaluation | | |
| | | SiO₂ + | Components of | | | Average | | | Open | | Glass | Falling | |
| | | MgO + | SiO₂, MgO, CaO | | | Crystal | Apparent | Open | Pore | | Elution | Granulated | |
| Sample | Al₂O₃ | CaO | SiO₂ | MgO | CaO | Particle | Density | Porosity | Diameter | Standard | Amount | Material | |
| No. | (%) | (%) | (wt %) | (wt %) | (wt %) | (μm) | (kg/m³) | (%) | (μm) | Deviation | (ppm) | (μm) | Evaluation |
| *28 | 99.3 | 0.6 | 2.8 | 97.0 | 0.2 | 1.2 | 3.88 × 10³ | 8.3 | 8.0 | 1.6 | 0.15 | 5.5 | Δ |
| *29 | ↑ | ↑ | 9.0 | 81.0 | 10.0 | 3.2 | 3.90 × 10³ | 5.2 | 4.9 | 1.4 | 0.12 | 5.2 | ◯ |
| 30 | ↑ | ↑ | 30.2 | 60.5 | 9.3 | 5.2 | 3.93 × 10³ | 3.6 | 3.8 | 0.9 | 0.09 | 3.9 | ⊚ |
| 31 | ↑ | ↑ | 12.2 | 59.0 | 28.8 | 5.6 | 3.93 × 10³ | 3.6 | 3.6 | 0.9 | 0.09 | 3.7 | ⊚ |
| 32 | ↑ | ↑ | 28.0 | 40.5 | 31.5 | 6.8 | 3.92 × 10³ | 3.8 | 3.5 | 0.9 | 0.10 | 3.6 | ⊚ |
| 33 | ↑ | ↑ | 61.1 | 31.0 | 7.9 | 8.3 | 3.91 × 10³ | 4.0 | 4.3 | 0.9 | 0.10 | 4.0 | ⊚ |
| 34 | ↑ | ↑ | 10.6 | 30.3 | 59.1 | 8.3 | 3.91 × 10³ | 4.4 | 4.3 | 1.0 | 0.10 | 4.6 | ⊚ |
| *35 | ↑ | ↑ | 53.3 | 22.2 | 24.5 | 13.0 | 3.89 × 10³ | 6.5 | 5.0 | 1.2 | 0.13 | 5.1 | ◯ |
| *36 | 99.5 | 0.4 | 3.3 | 96.6 | 0.1 | 1.1 | 3.87 × 10³ | 8.4 | 7.9 | 1.6 | 0.15 | 7.0 | Δ |
| *37 | ↑ | ↑ | 4.4 | 95.4 | 0.2 | 1.2 | 3.87 × 10³ | 8.0 | 8.1 | 1.5 | 0.14 | 7.6 | Δ |
| *38 | ↑ | ↑ | 2.6 | 95.2 | 2.2 | 1.2 | 3.87 × 10³ | 8.2 | 8.0 | 1.6 | 0.14 | 7.2 | Δ |
| *39 | ↑ | ↑ | 0.4 | 95.0 | 4.6 | 1.3 | 3.87 × 10³ | 7.6 | 7.8 | 1.5 | 0.14 | 7.0 | Δ |
| *40 | ↑ | ↑ | 7.1 | 90.1 | 2.8 | 2.0 | 3.88 × 10³ | 6.2 | 6.9 | 1.3 | 0.11 | 5.9 | ◯ |
| *41 | ↑ | ↑ | 2.3 | 91.1 | 6.6 | 1.8 | 3.88 × 10³ | 6.3 | 5.9 | 1.3 | 0.12 | 5.4 | ◯ |
| 42 | ↑ | ↑ | 10.3 | 79.5 | 10.2 | 3.8 | 3.91 × 10³ | 4.9 | 4.8 | 1.0 | 0.10 | 4.3 | ⊚ |
| 43 | ↑ | ↑ | 30.3 | 59.9 | 9.8 | 5.3 | 3.94 × 10³ | 2.1 | 2.4 | 0.9 | 0.08 | 2.6 | ⊚ |
| 44 | ↑ | ↑ | 10.9 | 58.1 | 31.0 | 5.4 | 3.94 × 10³ | 2.6 | 2.3 | 0.9 | 0.08 | 3.0 | ⊚ |
| 45 | 99.5 | 0.4 | 56.0 | 39.2 | 4.8 | 6.5 | 3.92 × 10³ | 3.8 | 3.4 | 0.9 | 0.09 | 3.2 | ⊚ |
| 46 | ↑ | ↑ | 29.6 | 40.0 | 30.4 | 6.8 | 3.92 × 10³ | 4.1 | 4.6 | 1.0 | 0.09 | 4.3 | ⊚ |
| 47 | ↑ | ↑ | 5.6 | 38.9 | 55.5 | 7.2 | 3.92 × 10³ | 4.0 | 4.2 | 1.0 | 0.10 | 4.2 | ⊚ |
| 48 | ↑ | ↑ | 33.9 | 32.9 | 33.2 | 9.8 | 3.91 × 10³ | 4.8 | 4.6 | 1.0 | 0.10 | 4.3 | ⊚ |
| 49 | ↑ | ↑ | 9.5 | 30.0 | 60.5 | 9.6 | 3.91 × 10³ | 4.9 | 4.5 | 1.0 | 0.10 | 4.8 | ⊚ |
| *50 | ↑ | ↑ | 60.1 | 29.8 | 10.1 | 11.2 | 3.90 × 10³ | 5.0 | 5.2 | 1.1 | 0.11 | 5.3 | ◯ |
| *51 | ↑ | ↑ | 54.6 | 19.3 | 26.1 | 12.1 | 3.90 × 10³ | 5.1 | 4.9 | 1.1 | 0.11 | 5.4 | ◯ |
| *52 | ↑ | 0.2 | 25.5 | 20.1 | 54.4 | 11.8 | 3.90 × 10³ | 5.2 | 5.0 | 1.1 | 0.11 | 5.2 | ◯ |
| *53 | 99.7 | ↑ | 3.0 | 96.8 | 0.2 | 1.1 | 3.86 × 10³ | 8.2 | 7.6 | 1.6 | 0.16 | 7.3 | Δ |
| 54 | ↑ | ↑ | 11.3 | 78.9 | 9.8 | 2.2 | 3.90 × 10³ | 4.9 | 4.8 | 1.0 | 0.10 | 4.6 | ⊚ |
| 55 | ↑ | ↑ | 31.5 | 59.3 | 9.2 | 4.5 | 3.91 × 10³ | 4.1 | 3.9 | 0.9 | 0.09 | 3.6 | ⊚ |
| 56 | ↑ | ↑ | 9.7 | 60.2 | 30.1 | 4.7 | 3.91 × 10³ | 3.4 | 4.2 | 0.9 | 0.09 | 4.0 | ⊚ |
| 57 | ↑ | ↑ | 28.5 | 41.4 | 30.1 | 5.2 | 3.91 × 10³ | 3.9 | 4.1 | 0.9 | 0.09 | 4.2 | ⊚ |
| 58 | ↑ | ↑ | 59.1 | 30.1 | 10.8 | 6.6 | 3.91 × 10³ | 4.0 | 3.9 | 1.0 | 0.10 | 4.1 | ⊚ |
| 59 | ↑ | ↑ | 10.9 | 30.0 | 59.1 | 7.0 | 3.91 × 10³ | 4.1 | 4.2 | 1.0 | 0.10 | 4.0 | ⊚ |
| *60 | ↑ | ↑ | 54.3 | 20.1 | 25.6 | 7.2 | 3.91 × 10³ | 4.3 | 4.6 | 1.1 | 0.11 | 5.2 | ◯ |

Sample numbers marked with * are not within the scope of the present invention.

From Table 6, in Samples Nos. 35, 50-52 and 60, which are less than 30.0% in composition ratio of MgO in the composition of three components of SiO₂, MgO and CaO, crystal is liable to grow in the form of grain because of less content of MgO, and the elution amount of glass is over 0.1 ppm because these Samples have a large value in open porosity, open pore diameter, and open pore standard deviation.

In Samples Nos. 28-29, 36-41 and 53, which are not less than 80% in composition ratio of MgO in the composition of three components of Sio₂, MgO and CaO, because of too much MgO, the activity of sintering is lowered and the apparent density is lowered so that these Samples have a large value in open porosity, open pore diameter, and open pore standard deviation. As a result, the elution amount of glass is over 0.1 ppm.

Samples, which are beyond the range of 30 to 80% in composition ratio of MgO in the composition of the three components, cause large variations in surface open pore diameter so that the open pore surface area of particles increases and therefore the area exposed to ink increases. Additionally, when the surface open pore standard deviation is large, the diameter of falling particles is large. This facilitates clogging of discharge holes.

In contrast, Samples in the scope of the present invention, namely, in the range of 30 to 80% in composition ratio of MgO in the composition of the three components, the crystal particle diameter is 1 to 10 μm, the apparent density is not less than 3.90×10³ kg/m³, and the surface open porosity is not more than 5.0%, the surface open pore diameter is not more than 5 μm, and the open pore standard deviation is not more than 1.0. Therefore, the glass elution amount is not more than 0.1 ppm, thereby enabling to reduce the diameter of falling granulated material.

### Example 7

The relationships between the specific surface area of Al₂O₃ powder and the characteristic of a ceramic forming body, and the sinterability were examined. That is, a support member 10 composed of an alumina sintered body was manufactured in the same manner as in Example 2, except that Al₂O₃ powder having a specific surface area indicated in Table 6 was used and formed under a forming pressure of 100 MPa by powder press method provided with a step pressing structure, followed by firing at a temperature of 1650° C. The surface condition of the obtained sintered body was evaluated in the same manner as in Example 1, and the surface open pore standard deviation was examined. The apparent density was measured according to JIS C 2141. Table 7 shows the results.

In Sample No. 69, its ceramic forming body was not dense and, in particular, the portions between ink delivery holes 11 of the flow passage member 10 were friable, failing to evaluate. The reason for this seems that the pressure transmission during powder press forming was dispersed because of too large specific surface area of the used Al₂O₃ powder.

TABLE 7

| | Specific Surface | Apparent | Surface Open Pore Condition | | |
|---|---|---|---|---|---|
| | Area of | Density of | Open | Open Pore | |
| | Al₂O₃Powder | Sintered Body | Porosity | Diameter | Standard |
| Sample No. | (m²/kg) | (kg/m³) | (%) | (μm) | Deviation |
| 61 | 0.1 × 10³ | 3.86 × 10³ | 4.9 | 5.0 | 1.2 |
| 62 | 0.3 × 10³ | 3.86 × 10³ | 4.6 | 4.9 | 1.1 |
| 63 | 0.5 × 10³ | 3.88 × 10³ | 4.4 | 4.3 | 1.0 |
| 64 | 1.1 × 10³ | 3.90 × 10³ | 4.0 | 3.9 | 1.0 |
| 65 | 3.3 × 10³ | 3.92 × 10³ | 3.8 | 3.7 | 0.9 |
| 66 | 5.2 × 10³ | 3.92 × 10³ | 3.8 | 3.3 | 0.8 |
| 67 | 7.9 × 10³ | 3.93 × 10³ | 2.7 | 2.9 | 0.9 |
| 68 | 15.0 × 10³ | 3.94 × 10³ | 2.3 | 2.5 | 0.8 |
| 69 | 20.5 × 10³ | — | — | — | — |

From Table 7, it can be seen that a dense alumina sintered body having good sinterability is obtained in Samples Nos. 63-68, the specific surface area of which is greater than 0.5×10³ m²/kg. The reason for this is estimated that the specific surface area of the Al₂O₃ powder is increased thereby to improve the activity of sintering. Especially in Samples Nos. 66-68, all of the apparent density, the surface open porosity, and the surface open pore diameter indicate good characteristics.

### Example 8

The relationships between the mean particle diameter of Al₂O₃ powder, the characteristic of a ceramic forming body, and sinterability were examined. A support member 10 composed of an alumina sintered body was manufactured in the same manner as in Example 2, except that Al₂O₃ powder having a mean particle diameter indicated in Table 8 was used and formed under a forming pressure of 100 MPa by powder press method provided with a step pressing structure, followed by firing at a temperature of 1650° C. The surface condition of the obtained sintered body was evaluated in the same manner as in Example 1, and the surface open pore standard deviation was examined. The apparent density was measured according to JIS C 2141. Table 8 shows the results.

In Sample No. 70, its ceramic forming body was not dense and, in particular, the portions between ink delivery holes 11 of the flow passage member 10 were friable, failing to evaluate. The reason for this seems that the pressure transmission during powder press forming was dispersed because of too large specific surface area of the used Al₂O₃ powder.

TABLE 8

| | Mean Particle | | Surface Open Pore Condition | | |
|---|---|---|---|---|---|
| | Diameter of | Apparent Density of | Open | Open Pore | |
| | Al₂O₃ Powder | Sintered Body | Porosity | Diameter | Standard |
| Sample No. | (μm) | (kg/m³) | (%) | (μm) | Deviation |
| 70 | 0.1 | — | — | — | — |
| 71 | 0.3 | 3.94 × 10³ | 2.5 | 2.8 | 0.8 |
| 72 | 0.5 | 3.93 × 10³ | 3.5 | 3.4 | 0.9 |
| 73 | 1.2 | 3.91 × 10³ | 3.8 | 3.7 | 0.9 |
| 74 | 1.8 | 3.90 × 10³ | 3.9 | 3.8 | 0.9 |
| 75 | 2.4 | 3.88 × 10³ | 4.1 | 4.0 | 1.0 |
| 76 | 3.0 | 3.88 × 10³ | 4.3 | 4.7 | 1.0 |
| 77 | 3.4 | 3.86 × 10³ | 4.9 | 4.9 | 1.2 |

From Table 8, Samples Nos. 71-77 indicate good characteristics in the surface open pore condition. In particular, Samples Nos. 71-76, the mean particle diameter of which is smaller than 3.0 μm, have a surface open pore standard deviation of not more than 1.0. Further, in Samples Nos. 71-74, a dense alumina sintered body is obtained because the apparent density is not less than 3.90×10³ kg/m³, and the surface open porosity is not more than 4.0%, and the surface open pore diameter is 4.0 μm.

1. An alumina sintered body comprising not less than 99.3% by weight of Al₂O₃, not more than 0.25% by weight of SiO₂, not more than 0.3% by weight of MgO, and not more than 0.3% by weight of CaO, and having a surface open porosity of less than 5%, and an average open pore diameter of not more than 5 μm.

2. The alumina sintered body according to claim 1, wherein the standard deviation of surface open pore is not more than 1.0.

3. The alumina sintered body according to claim 1, wherein the average crystal particle diameter is 1.0 to 10.0 μm.

4. The alumina sintered body according to claim 1, wherein the apparent density is not less than 3.90×10³ kg/m³.

5. The alumina sintered body according to claim 1, wherein the content of said MgO is 30.0 to 80.0% by weight in the composition ratio of three components of SiO₂, MgO and CaO.

6. An ink jet recording head structure comprising the followings:
(a) at least a surface exposed to ink is composed of an alumina sintered body comprising not less than 99.3% by weight of Al₂O₃, not more than 0.25% by weight of SiO₂, not more than 0.3% by weight of MgO, and not more than 0.3% by weight of CaO; and
(b) said alumina sintered body has a surface open porosity of less than 5% and an average open pore diameter of not more than 5 μm.

7. The ink jet recording head structure according to claim 6, wherein said surface exposed to ink has a surface open pore standard deviation of not more than 1.0.

8. The ink jet recording head structure according to claim 6, wherein the sum of elution amounts of Si, Mg and Ca from said surface exposed to ink under environment of an ink temperature of 20° C. to 60° C. is not more than 0.1 ppm/(cm²·day).

9. The ink jet recording head structure according to claim 6, wherein said alumina sintered body has an average crystal particle diameter of 1.0 to 10.0 μm.

10. The ink jet recording head structure according to claim 6, wherein the content of MgO of said alumina sintered body is 30.0 to 80.0% by weight in the composition ratio of three components of SiO₂, MgO and CaO.

11. The ink jet recording head structure according to claim 6, wherein said alumina sintered body has an apparent density of not less than 3.90×10³ kg/m³.

12. The ink jet recording head structure according to claim 6, comprising:
an ink jet recording head comprising a passage member having a plurality of ink chambers and a heat generating resistor for pressurizing ink disposed in each of said ink chambers, and a nozzle plate provided with an ink discharge hole in communication with said each ink chamber; and
a support member that supports said ink jet recording head and has an ink delivery hole in communication with said ink chambers of said passage member.

13. The ink jet recording head structure according to claim 12, wherein said support member is composed of said alumina sintered body.

14. The ink jet recording head structure according to claim 12, wherein said ink discharge hole has a diameter of 5 to 25 μm.

15. A method for manufacturing an alumina sintered body comprising: charging slurry containing Al₂O₃ powder having a means particle diameter of 0.1 to 3.0 μm in a die; forming it in a predetermined shape; and firing a resultant forming body, in order to obtain an alumina sintered body according to claim 1.

16. The method for manufacturing an alumina sintered body according to claim 15, wherein said forming body is fired at 1600 to 1750° C.

17. A method for manufacturing an ink jet recording head structure having a stepped through hole, comprising the steps of:
inserting part of a stationary punch in a first through hole of a die and inserting part of a floating punch in a second through hole of said stationary punch, thereby forming a stepped recess portion by use of said die, said stationary punch and said floating punch;
charging, in said stepped recess portion, ceramic granulated powder mainly comprising Al₂O₃ powder having a mean particle diameter of 0.1 to 3.0 μm, in order to obtain an alumina sintered body according to claim 1;
raising said floating punch such that a projected portion at a tip thereof is projected beyond ceramic material powder;
lowering an upper punch having a recess portion or a third through hole such that said projected portion of said floating punch is fitted in said recess portion or said third through hole of said upper punch;
further lowering said upper punch to pressurize said ceramic material powder and forcedly lowering said floating punch prior to completion of compression;
forming a ceramic forming body having a stepped through hole by, after lowering said floating punch, lowering said upper punch to a position of completion of compression; and
firing said ceramic forming body.

18. The method for manufacturing an ink jet recording head structure according to claim 17, wherein said ceramic powder is pressurized at a forming pressure of 80 to 150 MPa.

19. The method for manufacturing an ink jet recording head structure according to claim 17, wherein said Al₂O₃ powder has a specific surface area of 0.5 to 15.0 m²/g.

20. An ink jet printer comprising:
an ink jet recording head comprising a passage member having a plurality of ink chambers and a heat generating resistor for pressurizing ink disposed in each of said ink chambers, and a nozzle plate provided with an ink discharge hole in communication with said each ink chamber;
a support member that supports said ink jet recording head and has an ink delivery hole in communication with said ink chambers of said passage member; and
means for pressurizing ink in said ink chambers such that ink droplets are discharged from said ink discharge hole so as to print on recording paper by causing said heat generating resistor to develop heat so as to generate bubbles in said ink chambers in a state in which ink is supplied to said ink chambers from said ink delivery holes;
wherein in said passage member, said ink jet recording head and said support member, at least said support member is composed of an alumina sintered body according to claim 1.
